(19) United States
(12) Patent Application Publication
(10) Pub. No.: US 2008/0141985 A1
(43) Pub. Date: Jun. 19, 2008

(54) Layered core EGR cooler

(76) Inventors: Jeff L. Schernecker, Milwaukee, WI (US); Dan R. Raduenz, Burlington, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/641,378

(22) Filed: Dec. 18, 2006

(51) Int. Cl. F02M 25/07

(52) U.S. Cl. 123/568.12; 60/605.2; 165/167

(57) ABSTRACT

A combustion engine system (10) includes a combustion engine (11), a coolant system (46), an exhaust gas recirculation loop (32), and an exhaust gas cooler (34) connected in the loop (32) to transfer heat from the recirculating exhaust gas flow to a coolant flow supplied by the coolant system (46). The exhaust gas cooler (34) includes a plurality of coolant flow passages (66) interleaved with a plurality of recirculating exhaust gas flow passages (68), with the flow passages (66,68) being defined by a stack (60) of nested plates (62,64). Each of the plates (62,64) includes a peripheral flange (72,74) that is nested with the peripheral flange (72,74) of any adjacent nested plate (62,64) to enclose the flow passages (66,68).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention related to exhaust gas recirculation coolers.

### BACKGROUND OF THE INVENTION

Emission concerns associated with the operation of internal combustion engines, generally, but not always, diesel engines, have resulted in an increased emphasis on the use of exhaust gas heat exchange systems with such- engines, particularly, but not always, in vehicular applications. These systems are employed as part of an exhaust gas recirculation (EGR) system by which a portion of an engine's exhaust is returned to its combustion chambers via its intake system. The result is that some of the oxygen that would ordinarily be inducted into the engine as part of its fresh combustion air charge is displaced with inert gases thus reducing the rate of NOₓ formation. EGR systems are frequently designed to recirculate a cooled exhaust gas, thus lowering the combustion temperature and providing a reduction in NOₓ. To provide the cooled exhaust gas, exhaust gas recirculation coolers (EGR coolers) are often employed. In the usual case, engine coolant is brought into heat exchange relation with the exhaust gas to lower its temperature prior to recirculation. The design of such EGR coolers present a number of challenges, including cost and difficulty of manufacture. While there are many known EGR coolers that are suitable for the intended purpose, there is always room for improvement.

### SUMMARY OF THE INVENTION

In accordance with one feature of the invention, a combustion engine system includes a combustion engine having a combustion gas inlet and an exhaust outlet, a coolant system to supply a coolant flow for heat rejection, an exhaust gas recirculation loop connected to the exhaust outlet to receive a recirculating exhaust gas flow therefrom and to the combustion gas inlet to supply the recirculating exhaust gas flow thereto, and an exhaust gas cooler connected in the loop to transfer heat from the recirculating exhaust gas flow to the coolant flow. The exhaust gas cooler includes a stack of nested plates, each of the plates including a peripheral flange that is nested with the peripheral flange of any adjacent nested plate. Each plate defines a coolant flow passage on one side of the plate with an adjacent nested plate and an exhaust gas flow passage on an opposite side of the plate with another adjacent plate. The flow passages are enclosed by the nested flanges of each adjacent pair of plates.

According to one feature of the invention, a combustion engine system includes a combustion engine having a combustion gas inlet and an exhaust outlet, a coolant system to supply a coolant flow for heat rejection, an exhaust gas recirculation loop connected to the exhaust outlet to receive a recirculating exhaust gas flow therefrom and to the combustion gas inlet to supply the recirculating exhaust gas flow thereto, and an exhaust gas cooler connected in the loop. The cooler includes a plurality of coolant flow passages interleaved with a plurality of recirculating exhaust gas flow passages, the flow passages defined by a stack of nested plates. Each of the plates includes a peripheral flange that is nested with the peripheral flange of any adjacent nested plate to enclose the flow passages.

In one feature, each of the plates includes an embossed exhaust gas inlet opening, an embossed exhaust gas outlet opening, an embossed coolant inlet opening, and an embossed coolant outlet opening. Each embossed exhaust gas inlet opening is aligned with the exhaust gas inlet openings of the other plates to define an exhaust gas inlet manifold to distribute the recirculating exhaust gas flow to the exhaust gas flow passages. Each embossed exhaust gas outlet opening is aligned with the exhaust gas outlet openings of the other plates to define an exhaust gas outlet manifold to collect the recirculating exhaust gas flow from the exhaust gas flow passages. Each embossed coolant inlet opening is aligned with the coolant inlet openings of the other plates to define a coolant inlet manifold to distribute the coolant flow to the coolant flow passages, and each embossed coolant outlet opening is aligned with the coolant outlet openings of the other plates to define a coolant outlet manifold to collect the coolant flow from the coolant flow passages.

As one feature, every other plate in the stack includes an embossed, elongate bead to define a pair of passes for the coolant flow.

As another feature, every plate in the stack includes an embossed, elongate bead to define a pair of passes for the coolant flow.

As one feature, every plate in the stack includes embossed dimples extending to the coolant passage to enhance the distribution of coolant flow.

In accordance with one feature, every other plate in the stack includes embossed dimples extending into the coolant passage to enhance the distribution of the coolant flow.

According to one feature, the cooler further includes a plurality of fins, each fin located in one of the coolant flow passages or one of the exhaust flow passages.

In one feature, the engine system further includes a turbocharger connected to the combustion gas inlet to supply a charge airflow thereto.

As one feature, the engine system further includes an exhaust gas bypass valve connected in the exhaust gas recirculation loop to control the flow of the recirculating exhaust gas flow.

Other features and objects of the invention will become apparent from a detailed reading of the entire specification, including the appended claims and drawings.

### BRIEF DESCRIPTION OF THE DRAWINGS

FIG. 1 is a schematic of an internal combustion engine system including an exhaust gas recirculation (EGR) loop according to the present invention;

FIG. 2 is a perspective view of an EGR cooler utilized in the system of FIG. 1;

FIG. 3 is an exploded, perspective view of the EGR cooler of FIG. 2;

FIG. 4 is a perspective of one of the plates of the EGR cooler of FIGS. 2 and 3; and

FIG. 5 is an enlarged section view taken from line 5-5 in FIG. 4.

### DETAILED DESCRIPTION OF THE PREFERRED EMBODIMENT

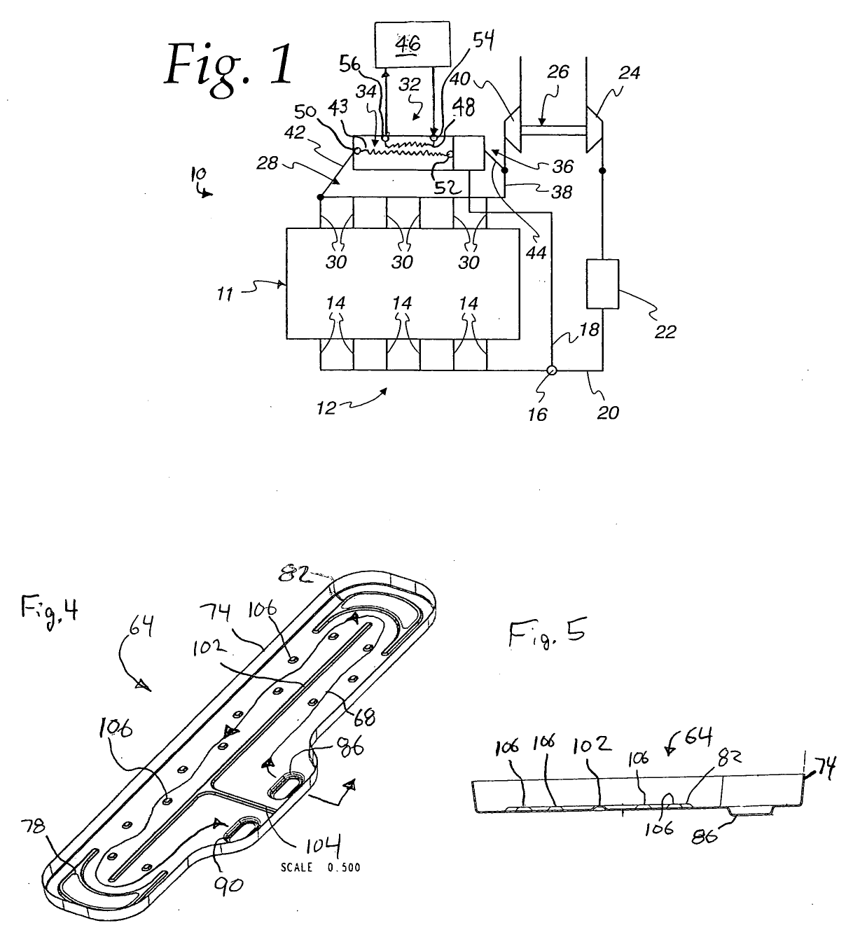

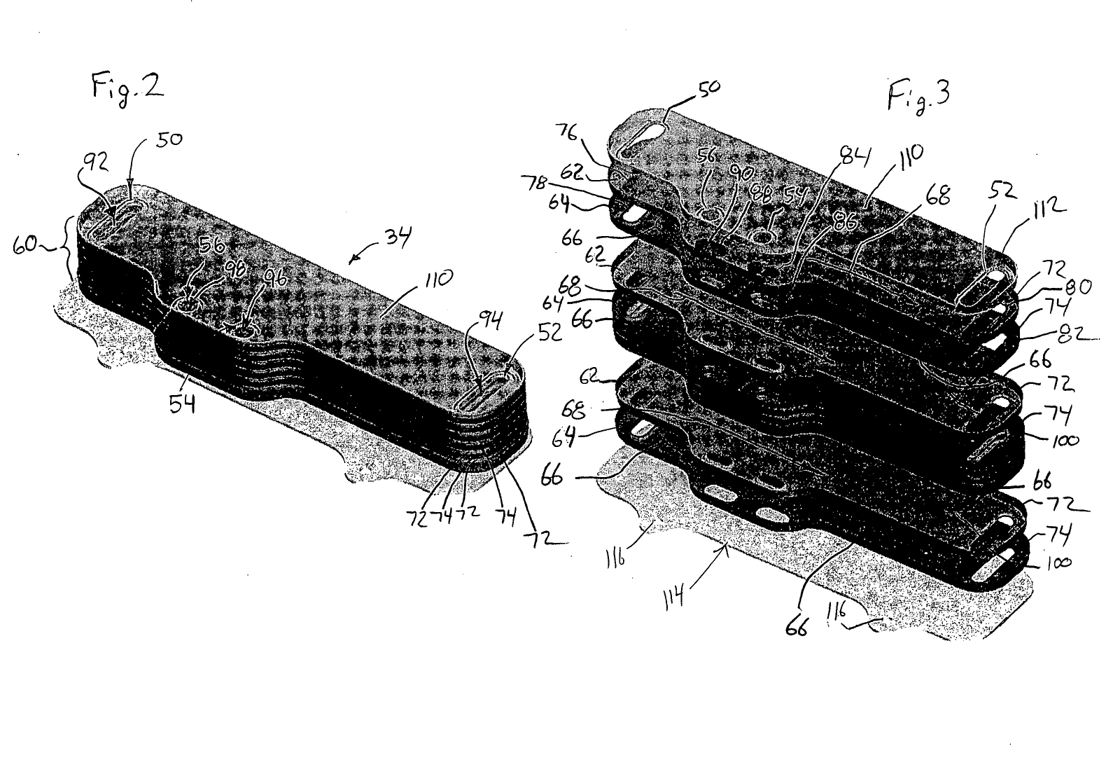

Referring first to FIG. 1, an exemplary embodiment of a combustion engine system 10 made according to the invention is described. The invention is described in the environment in which a typical diesel engine for a truck-like vehicle operates but it is to be understood that the invention is applicable to internal combustion engines other than diesel engines and may be employed in stationary engine applications as well as applications for engines other than trucks, as, for example, automobiles and construction, excavating, power generation, marine applications and others.

A diesel engine is generally designated 11 and includes an intake manifold 12 having outlet connections 14 to each of the cylinders of the engine 1 1. The intake manifold 12 includes a combustion gas inlet 16 for receiving recirculated exhaust gas from an exhaust gas recirculation line 18 as well as combustion air from a line 20. While a single inlet 16 is illustrated, the inlet 16 could actually be composed of multiple inlets, such as for example, an inlet for receiving the recirculated exhaust gas and another inlet for receiving the combustion air. Combustion air in the line 20 is preferably received from a charge air cooler 22 which in turn receives combustion air from the compressor side 24 of a turbocharger, generally designated 26. The engine 11 also includes an exhaust manifold 28 having a plurality of inlet connections 30, one to each of the cylinders of the diesel engine 10.

The system 10 further includes an exhaust gas recirculation (EGR) loop 32, with an EGR cooler 34 and a bypass valve 36 connected in the loop 32. The bypass valve 36 may be mounted on the EGR cooler 34 as shown, with both being mounted together on the manifold 28 in a conventional manner, or the valve 36 may be mounted separately from the EGR cooler 34. The exhaust manifold 28 preferably includes a connection on a line 38 to the turbine side 40 of the turbocharger 26 to provide a driving force whereby compressed air is compressed in the compressor side 24 and delivered to the charge air cooler 22 for ultimate delivery to the intake manifold 12. Near the opposite end of the exhaust manifold 28 is an exhaust gas recirculation outlet to a connecting line 42 extending to the EGR cooler 34 and an exhaust gas flow path 43 thereof. The opposite end of the exhaust gas flow path 43 discharges at the bypass valve 36. A connecting line 44 connects another inlet of the bypass valve 36 to the connection line 38. The bypass valve 36 includes an outlet connected to the recirculation line 18. As is conventional, the bypass valve 36 is preferably configured to direct cooled exhaust gas from the EGR cooler 34 to the recirculation line 18 or to direct uncooled exhaust gas from the exhaust manifold 28 to the recirculation line 18.

The engine system 10 also includes a coolant system 46 that supplies a coolant flow to a coolant flow path 48 of the EGR cooler 34 for the rejection of heat from the exhaust gas flow to the coolant flow. The coolant system 46 can be of any conventional design and may comprise a heat exchanger to cool the coolant, a pump and/or other appurtenances to remove heat from the coolant, as is known.

The EGR cooler 34 includes an inlet port 50 connected to the line 42 to receive the recirculating exhaust gas flow therefrom, an exhaust gas outlet port 52 connected to the bypass valve 36 to supply the recirculating exhaust gas flow thereto, a coolant inlet port 54 connected to the coolant system 46 to receive a coolant flow therefrom, and a coolant outlet port 56 connected to the coolant system 46 to return the coolant flow thereto. It should be understood that there are many possible ways to configure the ports 50, 52, 54 and 56 and that the details will be highly dependent upon each particular application. For example, in the illustrated embodiment, hose connections could be added to the coolant ports 54 and 56 and gasket flanges could be added to the exhaust ports 50 and 52. It should be appreciated that while the bypass valve 36 has been illustrated as being connected downstream from the EGR cooler 34, in some applications it may be advantageous to connect the bypass valve 36 at another location within the EGR loop 32, such as at a location upstream from the EGR cooler 34.

As best seen in FIGS. 3 and 4, the EGR cooler 34 includes a stack 60 of nested plates 62 and 64 that define a plurality of coolant flow passages, shown schematically by arrows 66, interleaved with a plurality of recirculating exhaust gas flow passages, shown schematically by arrows 68. Each of the plates 62 and 64 includes a peripheral flange 72 and 74, respectively, that is nested with the peripheral flange 72,74 of any adjacent nested plate 62,64 to enclose the flow passages 66 and 68. As best seen in FIG. 5, each of the peripheral flanges 72,74 (only 74 shown in FIG. 5) is flared or angled slightly outward as it extends away from the surface of the plate 62,64 so as to nest with the peripheral flange 72,74 of an adjacent plate 62,64. The flanges 72,74 eliminate the requirement for a separate coolant housing or jacket for the EGR cooler 34, and allow for the plates 62 and 64 to be self-locating when they are assembled into the stack 60 during the manufacture of the EGR cooler 34. Furthermore, the flanges 72,74 can provide for increased strength and/or durability of the EGR cooler 34 in comparison to conventional EGR coolers.

Each of the plates 62 and 64 includes an embossed exhaust gas inlet opening 76 and 78, respectively; an embossed exhaust gas outlet opening 80 and 82, respectively; an embossed coolant inlet opening 84 and 86, respectively; and an embossed coolant outlet opening 88 and 90, respectively. The exhaust gas inlet openings 76,78 are aligned with their embossed peripheries engaged so as to define an exhaust gas inlet manifold 92 to distribute the recirculated exhaust gas flow to the exhaust gas flow passages 68. The exhaust gas outlet openings 80,82 are aligned with their embossed peripheries engaged to define any exhaust gas outlet manifold 94 to collect the recirculated exhaust gas flow from the exhaust gas flow passages 68. The coolant inlet openings 84,86 are aligned with their embossed peripheries engaged to define an coolant inlet manifold 96 to distribute the coolant flow to the coolant flow passages 66, and the coolant outlet openings 88,90 are aligned with their embossed peripheries engaged to define a coolant outlet manifold 98 to collect the coolant flow from the coolant flow passages 66. In this regard, it should be understood that for each plate 62 and 64, the openings 76,80 and 78,82, respectively, are embossed to one side of the respective plate 62,64, and the coolant openings 84,88 and 86,90, respectively, are embossed to the opposite side of the respective plate 62,64.

It should be understood that there are multiple options for distributing the coolant in the coolant flow passages 66. A few examples are dimples embossed into at least one of the plates 62,64, inserting a fin in each of the coolant passages 66, or inserting a formed plate into each of the coolant passages 66. The distribution of the coolant through the coolant passage 66 will impact the effectiveness and durability of the EGR cooler 34 and the configuration will be selected highly dependent upon the specific parameters of each application. Furthermore, it should be understood that the positioning of the ports 56 and 54 and associated openings 84,86,88,90 and manifolds 96,98 can be changed according to packaging requirements and/or performance requirements of the EGR cooler 34. Similarly, the recirculating exhaust gas flow can be routed into and out of the EGR cooler 34 on either end, as shown in the illustrated embodiments, or to the sides, or any other positions as dictated by packaging and/or performance requirements, with the ports 50 and 52 and associated openings 76,80,78,82 and manifolds 92,94 being located as appropriate. As with the coolant flow, there are multiple options for distributing the recirculating exhaust gas flow in the exhaust gas flow passages 68, including for example, inserting a fin 1.00 in each of the exhaust gas flow passages 68 as shown in FIG. 3. One possibility for the coolant flow is best seen in FIG. 4 wherein an elongate bead 102 is provided centrally along the length of the plate 54 with a transverse bead 104 extending from the elongate bead 102 to between the coolant inlet and outlet openings 86 and 90 so as to define multiple passes in the coolant flow passage 68. Additionally, embossed dimples 106 are provided to enhance the distribution of the coolant flow across the surface of the plate 64 and the adjacent plate 62 which will have a surface that abuts the embossed beads and dimples. It should be appreciated that there are many alternatives for the embossed beads 102,104 and dimples 106. For example, beads 102,104 and dimples 106 could be provided in both of the plates 62 and 64, extending towards each other so as to abut.

In the illustrated embodiment, the EGR cooler 34 includes a top plate 110 having the ports 50, 52, 54 and 56 formed therein and including a peripheral flange 112 that nests with the peripheral flange 72 of the adjacent plate 62, and a bottom plate 114 that is imperforate in the areas underlying the manifolds 92, 94, 96 and 98 so as to seal the manifolds against leakage and includes a pair of mount openings 116 that can be utilized in mounting the EGR cooler 34 in the system 10.

Any suitable material, such as steel or aluminum, can be utilized for the components of the EGR cooler 34. Preferably, the EGR 34 is assembled and brazed, using a suitable braze technique, so that all of the mating surfaces and joints are bonded in a single operation.

1. A combustion engine system comprising:
a combustion engine having a combustion gas inlet and an exhaust outlet;
a coolant system to supply a coolant flow for heat rejection;
an exhaust gas recirculation loop connected to the exhaust outlet to receive a recirculating exhaust gas flow therefrom and to the combustion gas inlet to supply the recirculating exhaust gas flow thereto; and
an exhaust gas cooler connected in the loop to transfer heat from the recirculating exhaust gas flow to the coolant flow, the exhaust gas cooler comprising a stack of nested plates, each of the plates including a peripheral flange that is nested with the peripheral flange of any adjacent nested plate, each plate defining a coolant flow passage on one side of the plate with an adjacent nested plate and an exhaust gas flow passage on an opposite side of the plate with another adjacent plate, said flow passages enclosed by the nested flanges of each adjacent pair of plates.

2. The engine system of claim 1 wherein each of the plates comprises:
an embossed exhaust gas inlet opening aligned with the exhaust gas inlet openings of the other plates to define an exhaust gas inlet manifold to distribute the recirculating exhaust gas flow to the exhaust gas flow passages;
an embossed exhaust gas outlet opening aligned with the exhaust gas outlet openings of the other plates to define an exhaust gas outlet manifold to collect the recirculating exhaust gas flow from the exhaust gas flow passages;
an embossed coolant inlet opening aligned with the coolant inlet openings of the other plates to define a coolant inlet manifold to distribute the coolant flow to the coolant flow passages; and
an embossed coolant outlet opening aligned with the coolant outlet openings of the other plates to define a coolant outlet manifold to collect the coolant flow from the coolant flow passages.

3. The engine system of claim 1 wherein every other plate in the stack comprises an embossed, elongate bead to define a pair of passes for the coolant flow.

4. The engine system of claim 1 wherein every other plate in the stack comprises embossed dimples extending into the coolant passage to enhance the distribution of the coolant flow.

5. The engine system of claim 1 wherein the cooler further comprises a plurality of fins, each fin located in one of the coolant flow passages or one of the exhaust flow passages.

6. The engine system of claim 1 further comprising a turbocharger connected to the combustion gas inlet to supply a charge airflow thereto.

7. The engine system of claim 1 further comprising an exhaust gas bypass valve connected in the exhaust gas recirculation loop to control the flow of the recirculating exhaust gas flow.

8. A combustion engine system comprising:
a combustion engine having a combustion gas inlet and an exhaust outlet;
a coolant system to supply a coolant flow for heat rejection;
an exhaust gas recirculation loop connected to the exhaust outlet to receive a recirculating exhaust gas flow therefrom and to the combustion gas inlet to supply the recirculating exhaust gas flow thereto; and
an exhaust gas cooler connected in the loop, the cooler comprising a plurality of coolant flow passages interleaved with a plurality of recirculating exhaust gas flow passages, the flow passages defined by a stack of nested plates, each of the plates including a peripheral flange that is nested with the peripheral flange of any adjacent nested plate to enclose the flow passages.

9. The engine system of claim 9 wherein each of the plates comprises:
an embossed exhaust gas inlet opening aligned with the exhaust gas inlet openings of the other plates to define an exhaust gas inlet manifold to distribute the recirculating exhaust gas flow to the exhaust gas flow passages;
an embossed exhaust gas outlet opening aligned with the exhaust gas outlet openings of the other plates to define an exhaust gas outlet manifold to collect the recirculating exhaust gas flow from the exhaust gas flow passages;
an embossed coolant inlet opening aligned with the coolant inlet openings of the other plates to define a coolant inlet manifold to distribute the coolant flow to the coolant flow passages; and
an embossed coolant outlet opening aligned with the coolant outlet openings of the other plates to define a coolant outlet manifold to collect the coolant flow from the coolant flow passages.

10. The engine system of claim 8 wherein every other plate in the stack comprises an embossed, elongate bead to define a pair of passes for the coolant flow.

11. The engine system of claim 8 wherein every other plate in the stack comprises embossed dimples extending into the coolant passage to enhance the distribution of the coolant flow.

12. The engine system of claim 8 wherein the cooler further comprises a plurality of fins, each fin located in one of the coolant flow passages or one of the exhaust flow passages.

13. The engine system of claim 8 further comprising a turbocharger connected to the combustion gas inlet to supply a charge airflow thereto.

14. The engine system of claim 8 further comprising an exhaust gas bypass valve connected in the exhaust gas recirculation loop to control the flow of the recirculating exhaust gas flow.
